(19) United States
(12) Patent Application Publication
(10) Pub. No.: US 2013/0209983 A1
(43) Pub. Date: Aug. 15, 2013

(54) INTERACTIVE COMPUTER-ASSISTED STUDY/TEST/STUDY/TEST METHOD OF INSTRUCTION AND SYSTEM FOR IMPLEMENTATION

(71) Applicant: Edward Brown, Cleveland, TN (US)

(72) Inventor: Edward Brown, Cleveland, TN (US)

(21) Appl. No.: 13/843,503

(22) Filed: Mar. 15, 2013

Related U.S. Application Data
(63) Continuation-in-part of application No. 11/393,391, filed on Mar. 30, 2006.
(60) Provisional application No. 60/666,653, filed on Mar. 30, 2005.

(51) Int. Cl. G09B 7/06

(52) U.S. Cl. CPC G09B 7/06
USPC 434/353

(57) ABSTRACT

Disclosed is a testing and learning method comprising a testing system that registers a student as having passed a test when the student completes a testing option chosen from the group consisting of (1) answering one hundred percent of the questions in a set of questions within a required time, (2) answering one hundred percent of the questions in a series of sets of questions, but failing to answer any individual set of questions within the required time, and (3) providing a cumulative percentage of correct answers over a series of sets of questions.

### CROSS-REFERENCE TO RELATED APPLICATIONS

This is a continuation-in-part of U.S. patent application Ser. No. 11/393,391, filed Mar. 30, 2006, which claimed the benefit of earlier-filed U.S. Provisional Patent Application No. 60/666,653, filed Mar. 30, 2005. U.S. patent application Ser. No. 11/393,391 was published as U.S. Patent Application Publication Number US2006/0223040A1, the entire contents of which are incorporated herein by reference.

### FIELD OF THE INVENTION

The invention relates to a system and method for providing computer-based instruction. More specifically, the invention relates to a method for providing internet-accessible testing modules for use as both teaching and testing tools.

### BACKGROUND OF THE INVENTION

Computer-assisted learning has made it possible to better individualize certain aspects of instruction, and to provide learning activities outside the classroom for individual students. Nevertheless, building a conceptual framework for each student that a teacher can employ to help students visualize and comprehend relationships between concepts often remains a challenge to both students and teachers.

The word “failure” is used far too often in conjunction with descriptions of schools and students. Entire schools are categorized as “failing” because so few of their students are able to achieve the required levels of mastery at their grade levels. Students are described as “failing” because they fail to achieve test scores that demonstrate knowledge of required subject matter, and students are failing at an alarming rate. Unfortunately, the system is often designed in a way that promotes failure, because it does not take into account the fact that teachers in public and/or private schools are usually responsible for providing instruction and evaluating learning for from about 20 to about 150 students per day. Students learn at different rates, and the rate at which they learn is often associated with the subject, the student's level of interest, etc. Many educators agree that among the factors that are involved in educational achievement, two of the most important are getting students interested in learning and providing opportunities for them to succeed at learning and to feel successful. However, teaching multiple students at a time makes it more difficult to accomplish this by methods that have traditionally been available. Because students do learn at different rates, a system that requires that mastery be measured by a single test given on a pre-determined day almost guarantees failure for a student who is among those who may take longer to master the subject matter, but who, if given the time to do so, might still very successfully achieve mastery. Failure often becomes a pattern, robbing a student of the confidence that may be needed to learn new material.

The availability of desktop computers, laptops, and tablets has increased opportunities for individualizing instruction, but what are needed are new and better ways to utilize computers and the internet to promote student interest in learning and to help them to learn and to feel successful in their learning experiences, building confidence in their abilities to succeed.

### SUMMARY OF THE INVENTION

The present invention relates to a computer-assisted method for testing students, the method comprising (a) providing to a student a set of questions randomly selected from a collection of questions stored in a database forming a part of an internet-based computer testing system, (b) providing to the student a means to input into the system the student's answers to each question in the set of questions, and (c) assessing both the number of correct answers provided by the student and the time in which the student provided answers to all the questions in the set so that a student who answers all questions correctly for one quiz within a time specified by an instructor or who answers correctly all questions for multiple quizzes is registered by the system as having satisfactory comprehension of the subjects. Optionally, step (c) may also include the option of answering correctly a prescribed number of questions over a series of a prescribed number of quizzes covering the same subject matter.

The invention provides a method that uses knowledge-based and/or comprehension-based facts as questions, pictures, or audio corresponding to multiple-choice, word bank, or fill-in-the-blank answer formats which students may use to provide answers using a computer mouse and/or keyboard operably connected to a personal computer, laptop, tablet, etc. The method comprises randomly generating at least one set of questions for evaluating mastery of a subject; presenting to a student the set of questions as a quiz or exam through a system comprising a computer operably connected to an internet-accessible website and a website-associated database; providing to the student at least one data input form to provide the student with access to the system through the computer to input into the system the student's answers to the at least one set of questions; and assessing both the number of correct answers provided by the student and the time in which the student provided answers to the set of questions; and offering to the student three options for achieving acceptable mastery of a learning module, the options selected from the group consisting of (1) answering one hundred percent of the questions in the set of questions within a required time, (2) answering one hundred percent of the questions in a series of sets of questions, but failing to answer any individual set of questions within the required time, and (3) providing a cumulative percentage of correct answers over a series of sets of questions.

Sets of questions are presented to the student via the internet, graded immediately, and the results to individual questions are then displayed to provide virtually instant feedback to the student.

The invention also provides a testing and learning method comprising testing a student using testing system that registers a student as having passed a test when the student completes a testing option chosen from the group consisting of (1) answering one hundred percent of the questions in a set of questions within a required time, (2) answering one hundred percent of the questions in a series of sets of questions, but failing to answer any individual set of questions within the required time, and (3) providing a cumulative percentage of correct answers over a series of sets of questions. Preferably, the method is associated with an internet-accessible system and database of questions for operating the testing method.

### BRIEF DESCRIPTION OF THE DRAWINGS

FIG. 1 illustrates a system for use in the method of the invention, where 1 is a computer operated by an instructor, 2 is an internet-accessible website comprising access to a database comprising TRQ questions and answers, and programming code to allow user interaction with the database elements, and 3 is a computer operated by a student.

FIG. 2 illustrates the scoring options of the present invention that are presented to the student.

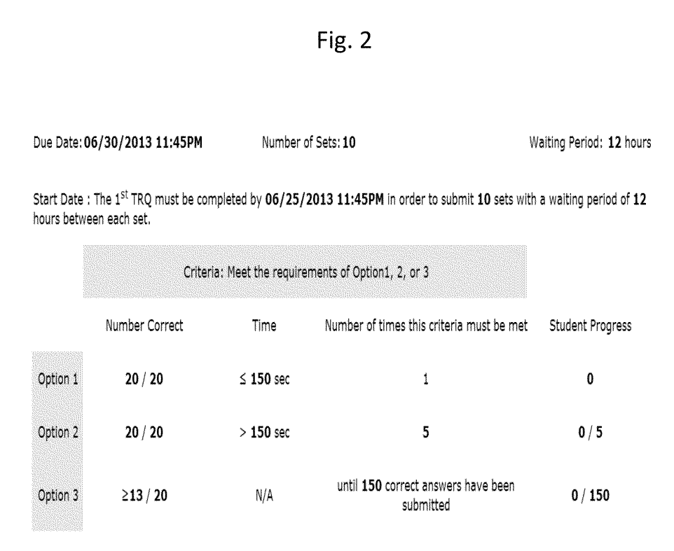

### DETAILED DESCRIPTION

The inventor has developed a method for increasing student comprehension and allowing students to achieve mastery of subject matter at their own individual rates by a method that involves timed, repeated quizzing. The method promotes learning because both retrieval of information (by thinking about questions and providing answers to those questions) and immediate feedback (by being presented with a “graded” quiz immediately after completion of a quiz) promote retention of learned material. Frequent quizzing, especially when done via computer on an individualized basis, increases retrieval efficiency and reduces test anxiety. The method provides options for the student to achieve a required number of points for a particular class, so that a student who may need more time to understand and retain the material presented in class or online will not be penalized, but may, if the student is willing to devote the additional time to the learning process, be given the opportunity to demonstrate the necessary understanding and retention of subject material without having to do so on a pre-determined “test day,” as is traditionally done in most classrooms.

The invention comprises a computer-assisted method for testing students, using knowledge-based and/or comprehension-based facts as questions, pictures, or audio corresponding to multiple-choice, word bank, or fill-in-the-blank answer formats which students may use to provide answers using a computer mouse and/or keyboard. The method comprises randomly generating at least one set of questions for evaluating mastery of a subject; presenting to a student the set of questions as a quiz or exam through a system comprising a computer operably connected to an internet-accessible website and a website-associated database; providing to the student at least one data input form to provide the student with access to the system through the computer to input into the system the student's answers to the at least one set of questions; and assessing both the number of correct answers provided by the student and the time in which the student provided answers to the set of questions; and offering to the student three options for achieving acceptable mastery of a learning module, the options selected from the group consisting of (1) answering one hundred percent of the questions in the set of questions within a required time, (2) answering one hundred percent of the questions in a series of sets of questions, but failing to answer any individual set of questions within the required time, and (3) providing a cumulative percentage of correct answers over a series of sets of questions.

Sets of questions are presented to the student via the internet, graded immediately, and the results to individual questions are then displayed to provide virtually instant feedback to the student. Knowledge is efficiently moved from a written, visual, or audio format to a student's memory by repetition, feedback, and active involvement. The ability of repeated Study/Test (ST) trials to increase recall was observed by Ebbinghaus (1885/1964) and spurred research activity on the effects of repetition on learning. A common assumption in the ST trials is that learning only occurs during the study phase and that test trials are neutral events that simply assess learning. To test this assumption, Karpicke and Roediger (2007) conducted an experiment that compared STST (Standard), SSST (Repeated Study) and STTT (Repeated Test). Their results showed that repeated testing (STTT) produced more long-term knowledge retention than repeated study (SSST) and that learning occurs during both activities. However, the optimal condition for learning proved to be the standard condition (STST), presumably because this condition contains more frequent feedback. Given these results, it is interesting that the advice given by teachers to students is SSST (“study, study, study for the test”) when it should be STST. Teachers may be reluctant to use the STST approach because it requires a significant amount of time (a scarce commodity in education) to create, administer and grade a test.

A series of online timed quizzes are made available to the student by the system as assigned by the instructor. The quizzes are structured to be completed in one of two ways: a student must score 100% and beat (or tie) the time established by the instructor and entered into the system by the instructor or a student must score 100% on multiple quizzes (without ever beating/tying the required time). A third option may also be presented: completing a prescribed number of quizzes for which a student has scored at or above a pre-determined percent of correct answers, the percentage of correct answers required being determined by the student's instructor. The number of multiple quizzes required of the student in the second and third circumstance may be established by the instructor and the quizzes need not be consecutive. Generally, it has been common practice in the past to provide a test to a student a group of students and give them a predetermined time in which to complete the test. Students who understand the material sufficiently to answer a significant percentage of questions within the allotted time receive positive feedback and move on to the next lesson. Unfortunately, however, students who cannot answer a significant percentage of the questions correctly, or who cannot complete the questions in the required time, are penalized--yet no remedial action is taken at that time. An unsatisfactory grade is recorded and the student is expected to move on with the rest of the class to begin the next instructional unit. The system and method of the present invention provide an opportunity for students who have achieved mastery of the subject to complete the assigned quiz or test and then spend their time on other matters as they choose--but it does not simply penalize those who have not mastered the subject and force them to move on from that point without addressing their need to better understand the concepts that have just been presented to them. By providing a series of quizzes or tests to these students by computer-assisted means, it is possible to note their lack of comprehension at the time of the test while allowing them to continue to try to master the subject material through a series of repetitive quizzes that make them think about the question and the answer and focus their attention on the material.

An instructor may customize each timed quiz by removing elements from the quiz, setting the time, setting the number of times and determining the points. When the student first selects the quiz on the computer screen, he/she is given information about the quiz and shown the information (selected by the instructor) that will be on the quiz. The answers to the quiz may be posted on the same page as the quiz. If a student has already mastered the material, he/she will be able to quickly answer the questions within the allotted time. If a student must look at the answers, he/she will not be able to complete it in the minimum time and will be required to take multiple quizzes. In the method of the invention, a student may receive credit for completing a quiz within one attempt or within multiple attempts. Students who quickly master the concepts and are able to correctly answer the questions are therefore free to complete the assignment and devote their time to other endeavors. Exams given in timed format can aid an instructor in determining whether a student has internalized the concept sufficiently to be able to recall it quickly, or the student must look up the information required to answer the question—a process that may require significantly more time. For those students who can answer the required number of questions in the assigned time, the grade is recorded upon completion of the quiz or exam. For those students who cannot answer the required number of questions in the allotted time, the instructor may require that the student take a series of quizzes or exams that cover the same concepts. These may comprise the same questions, but more preferably would provide a new set of questions related to the same concepts so that the student must think about the concept in order to attempt to answer the new question regarding the same concept. These questions may be randomly generated to form a series of quizzes or exams that the student can take until a required number of questions are correctly answered in a prescribed time, or a required number of quizzes or exams are taken to provide the student with an opportunity to focus on the concept and, through spaced repetition, to learn those concepts that were unclear to the student upon beginning the first quiz or exam.

The present timed repetitive quiz/test (TRQ) invention produces a repeated STST learning model where the instructor's test-creation and grading times are essentially eliminated. In the method of the invention, a teacher simply selects TRQ questions from indexed keywords presented to the teacher via a website to create unique questions pools for their class and the test is then assembled by the computerized system. Detailed reports showing both individual and group student progress may be available to a teacher via the same system and website.

Requiring students to answer questions promotes active involvement in retrieving items from memory. It is the retrieval of information that creates the mental pathways necessary for remembering. Recent psychological research suggests that a quizzing intervention aids in knowledge retention. Karpicke and Blunt (2011) found that students who read a passage and then took a quiz asking them to recall what they had read, retained about 50 percent more of the information a week later than students who used other popular methods of information retention. They postulate that the first retrieval of a fact created a mental pathway that the brain remembers a week later. Subsequent retrievals of this fact begin to create a more permanent memory representation that can be accessed through a more solidified retrieval route. To maintain this knowledge store in long-term memory, students must be continually exposed to the material even after recall has been achieved. This process, called overlearning, is a recommended technique to achieve long-term retention (Driskell, Willis, & Cooper, 1992). In its proposed implementation, once learned, TRQ question pools will be placed on a review cycle to maintain the overlearned status of the information until the end of the school year when the student leaves the instructor's classroom.

For centuries, tests have been used as a tool for evaluating student learning. In more recent times, tests have not only been used as a tool for evaluating student learning, but have also been used as a tool for evaluating an instructor's efficacy and even as a tool for evaluating the efficacy and validity of specific test questions. For example, standardized tests given in various states not only measure student achievement, but are also used to evaluate an individual classroom teacher's performance—or the performance of an entire school as a learning environment. In other situations, educators may utilize information such as the time it takes a student to answer an individual question and the number of times that the question is incorrectly answered by a group of students to determine whether or not the subject was presented in a manner that produced understanding by the student group or the test question was misunderstood by the students.

The invention utilizes quizzes and/or tests as teaching tools as much, or more than, as tools for evaluation. The invention provides individualized assistance in memory formation (with associated record-keeping of the learning activity/activities). Since knowledge acquisition and memory formation require a sizeable investment of time, the computerized mentor/student interaction can provide a time-based link between a classroom teacher and all students at the same time. Each student's interaction with assigned information, whether new material or re-visited material, is monitored, which permits close accountability between the student and teacher.

Questions are presented as text, pictures, and/or audio and contain knowledge items from one or more specified content area(s). For example, TRQ questions for 3^{rd} grade math may contain 15-25 sets of flash cards, grouped by common content, that are assigned at various times throughout the year. Each time a new set is introduced, students will spend time (e.g., 20-25 minutes) taking TRQs on consecutive days until a specified level of performance is attained. Periodically, each set of previously learned flash cards will be revisited to maintain the learned information.

The method of the invention is suitable for subjects as varied as mathematics, language, social studies, geography, civics, biology, chemistry, physics, health science, physical science, etc.

The TRQ invention is operationally unique from other learning methods in that the same number of points is awarded for completing any one of the offered options for demonstrating subject mastery. Providing multiple paths to complete an assignment may not seem significant, but options often eliminate resistive attitudes that can sabotage the learning process. In the method of the invention, a student is given three options for demonstrating mastery of subject matter to a level pre-determined by the student's instructor. For example, a student may either (1) achieve a perfect score on a quiz within a time limit set by the student's instructor, (2) achieve a perfect score on a specified number of quizzes, without completing any of those quizzes within a time limit, or (3) achieve a specified minimum score on a number of quizzes that is predetermined by the student's instructor. For the third option, the number of quizzes will generally be enough to provide the student with multiple opportunities to review the material while completing the quizzes.

A multitude of questions covering a variety of subjects can be delivered and graded by the TRQ system. The various options available for demonstrating mastery keep students actively involved at various levels of learning while they gain comprehension and increase retrieval efficiency. Certifying a student as “successful” produces an incentive to continue the effort. Constructing a learning paradigm where a student's time investment is minimal only if they possess subject mastery and retrieval efficiency, as demonstrated by completion of a quiz with a perfect score within a prescribed time, represents a unique approach to encourage students toward learning so they can save study time and generate more free time. Furthermore, the TRQ method awards “credit for effort.” The same credit is given for varying periods of effort and levels of initial success. The significant difference between the various options is the amount of time a student must invest. The ultimate goal is to assist the student in developing his/her own abilities to achieve the highest level of learning with the smallest investment of time. One of the goals of the method is to assist the student in developing skill in analyzing information and reducing test anxiety. That goal could also be described, in the words of poet Ogden Nash, as “to err, and err, and err again, but less, and less, and less.”

Computer, server, and other elements for providing computer-assisted instruction via the internet are known to those skilled in the art. Programming languages and programs (e.g., Flash® (Adobe Systems, Inc.)) to facilitate performance of specific operations via computer are also known to those of skill in the art. The inventor has developed a system that utilizes those elements to deliver interactive testing/instructional materials to students. The system utilizes the known elements of servers, internet routers and modems, and personal computers in conjunction with the novel elements associated with the website and database that provide Timed Repetitive Quizzing in an interactive manner to better prepare the student for participation in classroom activities.

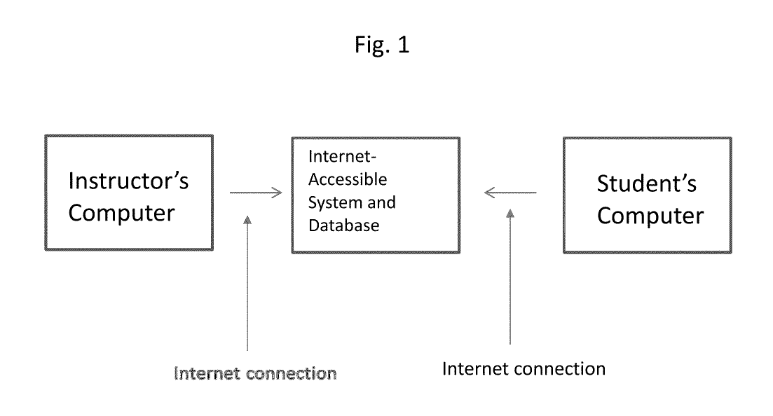

A system such as that provided by the present invention is shown in FIG. 1, where 1 is a computer operated by an instructor, 2 is an internet-accessible website comprising access to a database comprising TRQ questions and answers, and programming code to allow user interaction with the database elements, and 3 is a computer operated by a student. A series of online timed quizzes are made available to the student by the system, as previously assigned by the instructor. The quizzes are structured to be completed in one of two ways: a student must score 100% and beat (or tie) the time established by the instructor and entered into the system by the instructor, or a student must score a certain percentage on multiple quizzes and the quizzes need not be consecutive. If the percentage is 100% in the second circumstance, then the quiz submission time is not required to beat or tie the TRQ quiz time. Generally, it has been common practice in the past to assess a student's subject-matter comprehension by giving a test with a set test time. Students who understand the material sufficiently to answer a significant percentage of the questions within the allotted time receive high marks and move on to the next lesson. Unfortunately, however, students who cannot answer a significant percentage of the questions correctly, or who cannot complete the questions in the required time, are penalized with a low mark on the assignment—yet no remedial action is generally taken at that time. An unsatisfactory grade is recorded and the student is expected to move on with the rest of the class to begin the next instructional unit. The system and method of the present invention provide an opportunity for students who have achieved mastery of the knowledge- and comprehension-based components of a unit to complete the TRQ and then spend the remaining time on other matters. The students who have not mastered the material covered in the unit are not penalized or forced to move on, but they are permitted more time to successfully complete the TRQ by one of the means described above. By providing a series of quizzes to students by computer-assisted means, it is possible to differentiate among students in the class by allowing those students who achieve mastery (can correctly answer all the TRQ questions) and retrieval efficiency (can correctly answer all the TRQ questions in a short period of time) of the material to demonstrate that with a minimal investment of student time being spent on the evaluation, while at the same time providing a route for students who understand the material but may need help in developing retrieval efficiency by providing the option of correctly answering all questions in a series of quizzes without completing any one quiz within a required time. For students who lack the requisite level of subject-matter comprehension, the third option provides both an opportunity for successfully achieving the desired number of points and an opportunity to spend additional time reviewing the material by submitting, for example, 15 quizzes that are 50% correct. Students who lack fluency and retrieval efficiency by the time the instructor is prepared to evaluate the students as a whole will therefore be required to interact over longer periods of time with the knowledge- and comprehension-based components of the material, rather than being positioned to fail on a standard test and then moving on to the next subject matter without having the opportunity to invest the time to learn more.

An instructor may customize a timed quiz by removing/adding elements from the quiz, setting the time, setting the number of times a quiz must meet a certain criteria, and determining the point structure for the quizzes. When the student first selects a quiz on the computer screen, he/she is given information about the quiz and shown the questions (selected by the instructor) that will be on the quiz. The answers to a quiz may be posted on the same page with the questions—and in this case the webpage serves as a “study sheet” for the quiz. If a student has fluency and retrieval efficiency of the quiz material, he/she will be able to quickly answer the questions within the allotted time, scoring 100% before the timer reaches 0 seconds. If a student must look up the answers, he/she will not be able to submit a completely correct quiz AND beat (or tie) the timer. The student will be required to take additional quizzes until they have submitted a certain number of quizzes that meet a teacher-specified level of correctness (e.g. 10 TRQs at 100% each, or 20 TRQs at 60% or higher) where none of the quizzes are 100% correct and beat (or tie) the timer. Students who quickly master the concepts and are able to quickly answer correctly all the TRQ questions are then free to complete other assignments or participate in other activities approved by the instructor.

As students take and retake TRQs throughout the course of a semester or school year, the TRQ program weights each question asked to an individual student based on whether the student answered it correctly or incorrectly. Questions that have the highest “incorrect” weight are much more likely to appear on a subsequent TRQ than a question that the student has been answering correctly. In addition, the weighting mechanism does have a maximum value for incorrect (and correct) questions and missing a question that has the maximum weight assigned to it will not increase its weight.

A web-based administration page allows an instructor to input preferences into the system regarding the administration and grading of TRQs. The instructor can select the TRQ questions, set the number of questions that comprise a single TRQ, set the starting value for the Timer, set the criteria that constitutes completion of a TRQ (100% correct in less than 50 seconds; 100% correct on 5 different quizzes where each quiz time exceeds 50 seconds; or ≧60% correct on 15 different quizzes where each quiz time exceeds 50 seconds, for example), set the points awarded once a TRQ is certified as “completed”, and the time a student must wait before retaking the same TRQ for additional credit.

While most educators would agree that establishing incremental goals is an effective learning strategy, the current education system generally does not provide the resources to incrementally assess (grade) student performance. The more infrequent the grading, the longer it takes to identify students who may need additional time, additional help from the instructor, etc., to reach the learning goal.

The TRQ method provides multiple paths for earning the same number of points, but the path that represents fluency and retrieval efficiency requires the least amount of time. The method promotes long-term retention through repeated retrieval attempts and encourages improved retrieval efficiency. The method provides instant feedback by showing the questions, the student answers, and the correct answers. The method also reduces classroom teacher time spent in preparing and grading quizzes and tests, allowing the teacher to focus that time on preparation of learning materials and giving students more one-on-one instruction.

What is claimed is:

1. A computer-assisted method for testing students using an internet-accessible system, the method comprising (a) providing to a student a test comprising a set of questions randomly selected from a collection of questions stored in a database, (b) providing to the student a means to input into the system the student's answers to each question in the set of questions, and (c) assessing both the number of correct answers provided by the student and the time in which the student provided answers to all the questions in the set, so that a student who answers all questions correctly for one quiz within a time specified by an instructor, or who answers correctly all questions for multiple quizzes without doing so within a specified time, is registered by the system as having passed the test.

2. The method of claim 1, wherein step (c) comprises an additional option for the student, the option being answering correctly a prescribed number of questions over a series of a prescribed number of quizzes covering the same subject matter.

3. A testing and learning method comprising testing a student using a testing system that registers a student as having passed a test when the student completes a testing option chosen from the group consisting of (1) answering one hundred percent of the questions in a set of questions within a required time, (2) answering one hundred percent of the questions in a series of sets of questions, but failing to answer any individual set of questions within the required time, and (3) providing a cumulative percentage of correct answers over a series of sets of questions.
